(19) United States
(12) Patent Application Publication
(10) Pub. No.: US 2025/0153258 A1
(43) Pub. Date: May 15, 2025

(54) CIRCULAR SAW DUST COLLECTION SYSTEMS AND ATTACHMENTS FOR CIRCULAR SAWS

(71) Applicants: Russell Matson, Papillion, NE (US); Warren Matson, Omaha, NE (US)

(72) Inventors: Russell Matson, Papillion, NE (US); Warren Matson, Omaha, NE (US)

(21) Appl. No.: 18/505,775

(22) Filed: Nov. 9, 2023

(51) Int. Cl. B23D 59/00

(52) U.S. Cl. CPC B23D 59/006

(57) ABSTRACT

A dust collection attachment is to be positioned between a side of a blade guard and a support base of a circular saw assembly. The dust collection attachment is for coupling with a vacuum source to remove debris drawn into the dust collection attachment. The dust collection attachment includes an elongated front face for filling space between the side of the blade guard and the support base, a top edge to extend along the side of the blade guard, a bottom edge to extend along the support base, and defines an opening for receiving the debris drawn into the dust collection attachment. The dust collection attachment also includes an extension of the elongated front face and a connection opposite the opening. The dust collection attachment further includes a passageway defined through the dust collection attachment from the opening at the elongated front face to the connection opposite the opening.

### BACKGROUND

Circular saws use toothed or abrasive discs or to cut material using a rotary motion, e.g., where a disc or blade spins about an arbor.

### DRAWINGS

The Detailed Description is described with reference to the accompanying figures. The use of the same reference numbers in different instances in the description and the figures may indicate similar or identical items.

FIG. 1 is an isometric view illustrating a circular saw assembly including a tool body, an arbor mount, a blade guard, a support base, and a dust collection attachment positioned between the blade guard and the support base in accordance with example embodiments of the present disclosure.

FIG. 2 is another isometric view of the circular saw assembly including the dust collection attachment illustrated in FIG. 1.

FIG. 3 is an exploded isometric view of the circular saw assembly including the dust collection attachment illustrated in FIG. 1.

FIG. 4 is another exploded isometric view of the circular saw assembly including the dust collection attachment illustrated in FIG. 1.

FIG. 5 is a further exploded isometric view of the circular saw assembly including the dust collection attachment illustrated in FIG. 1.

FIG. 6 is a side elevation view of the circular saw assembly including the dust collection attachment illustrated in FIG. 1.

FIG. 7 is another side elevation view of the circular saw assembly including the dust collection attachment illustrated in FIG. 1.

FIG. 8 is a partial cross-sectional front elevation view of the circular saw assembly including the dust collection attachment illustrated in FIG. 1.

FIG. 9 is a partial cross-sectional isometric view of the circular saw assembly including the dust collection attachment illustrated in FIG. 1.

FIG. 10 is another partial cross-sectional isometric view of the circular saw assembly including the dust collection attachment illustrated in FIG. 1.

FIG. 11 is an isometric view illustrating a dust collection attachment for a circular saw assembly, such as the dust collection attachment illustrated in FIG. 1, in accordance with example embodiments of the present disclosure.

FIG. 12 is another isometric view of the dust collection attachment illustrated in FIG. 11.

FIG. 13 is a further isometric view of the dust collection attachment illustrated in FIG. 11.

FIG. 14 is another isometric view of the dust collection attachment illustrated in FIG. 11.

FIG. 15 is a further isometric view of the dust collection attachment illustrated in FIG. 11.

FIG. 16 is another isometric view of the dust collection attachment illustrated in FIG. 11.

FIG. 17 is a further isometric view of the dust collection attachment illustrated in FIG. 11.

FIG. 18 is another isometric view of the dust collection attachment illustrated in FIG. 11.

FIG. 19 is a top plan view of the dust collection attachment illustrated in FIG. 11.

FIG. 20 is a bottom plan view of the dust collection attachment illustrated in FIG. 11.

FIG. 21 is a front elevation view of the dust collection attachment illustrated in FIG. 11.

FIG. 22 is a rear elevation view of the dust collection attachment illustrated in FIG. 11.

FIG. 23 is a left side elevation view of the dust collection attachment illustrated in FIG. 11.

FIG. 24 is a right side elevation view of the dust collection attachment illustrated in FIG. 11.

FIG. 25 is a partial cross-sectional left side elevation view of the dust collection attachment illustrated in FIG. 11.

FIG. 26 is a partial cross-sectional right side elevation view of the dust collection attachment illustrated in FIG. 11.

FIG. 27 is a partial cross-sectional isometric view of the dust collection attachment illustrated in FIG. 11.

FIG. 28 is another partial cross-sectional isometric view of the dust collection attachment illustrated in FIG. 11.

FIG. 29 is a further partial cross-sectional isometric view of the dust collection attachment illustrated in FIG. 11.

FIG. 30 is another partial cross-sectional isometric view of the dust collection attachment illustrated in FIG. 11.

### DETAILED DESCRIPTION

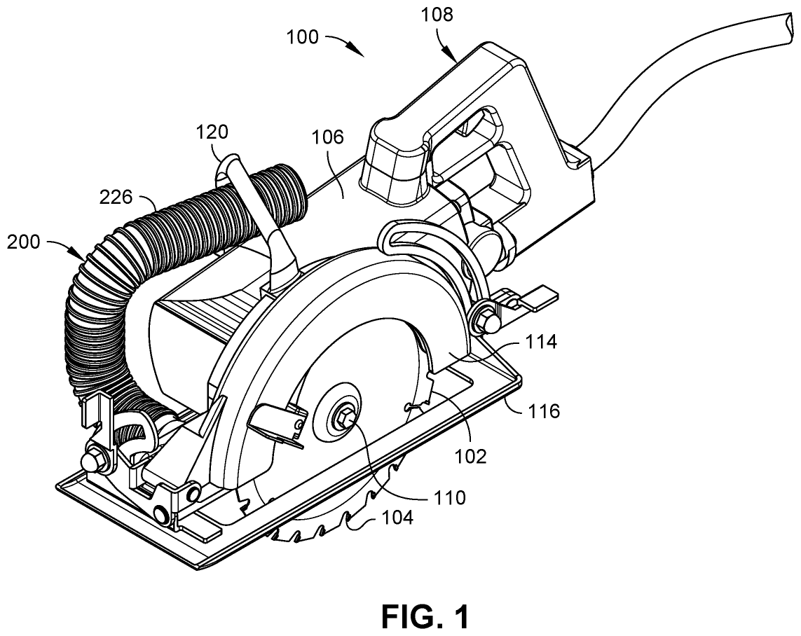

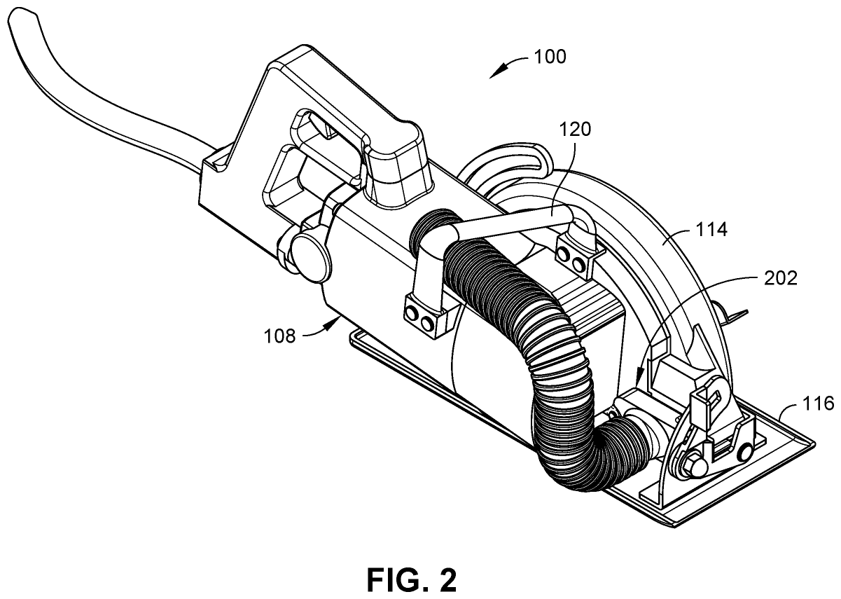

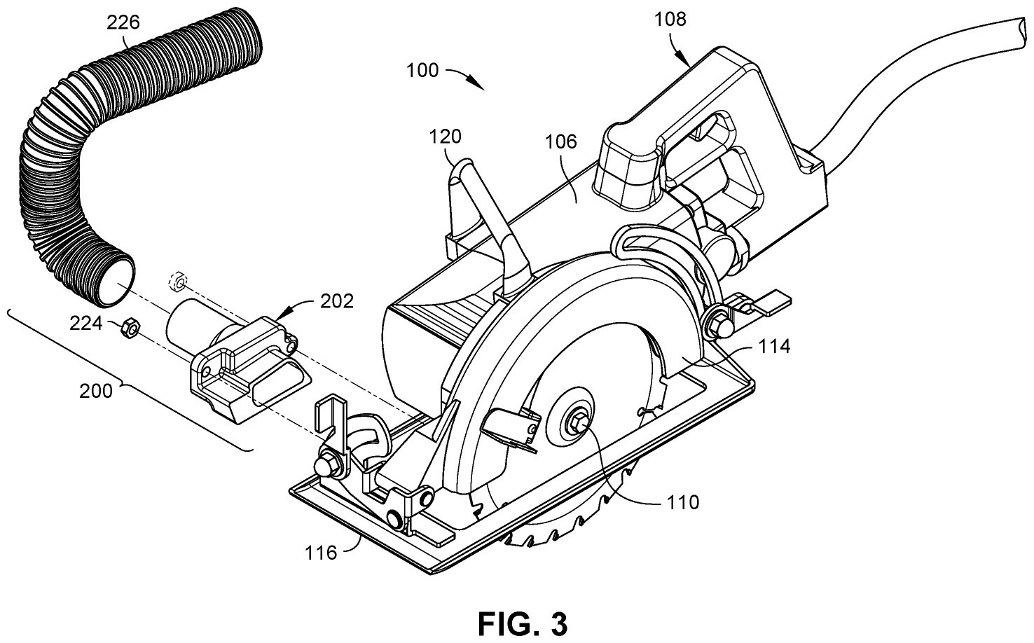

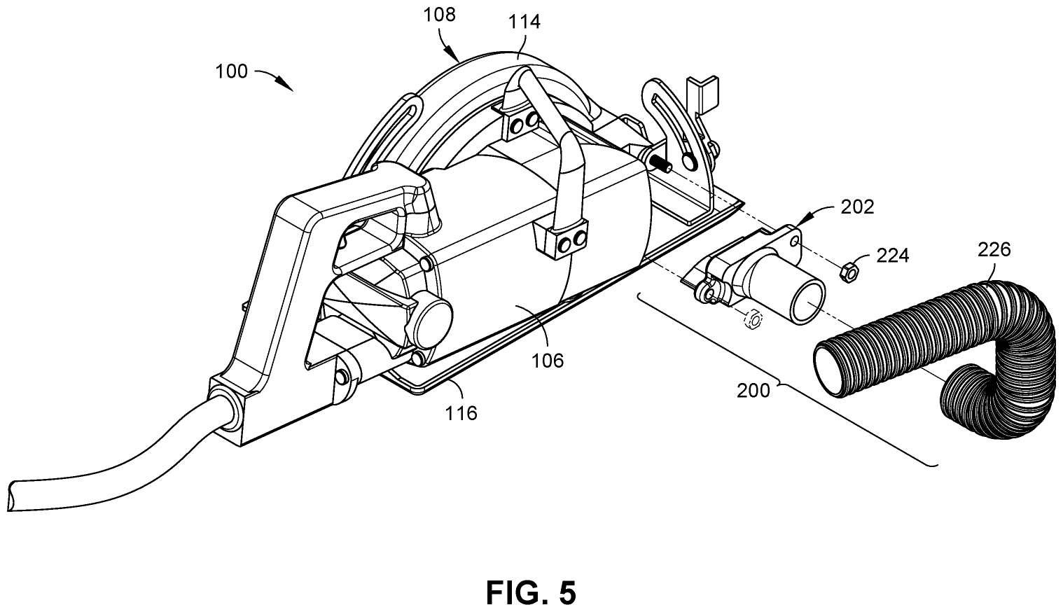

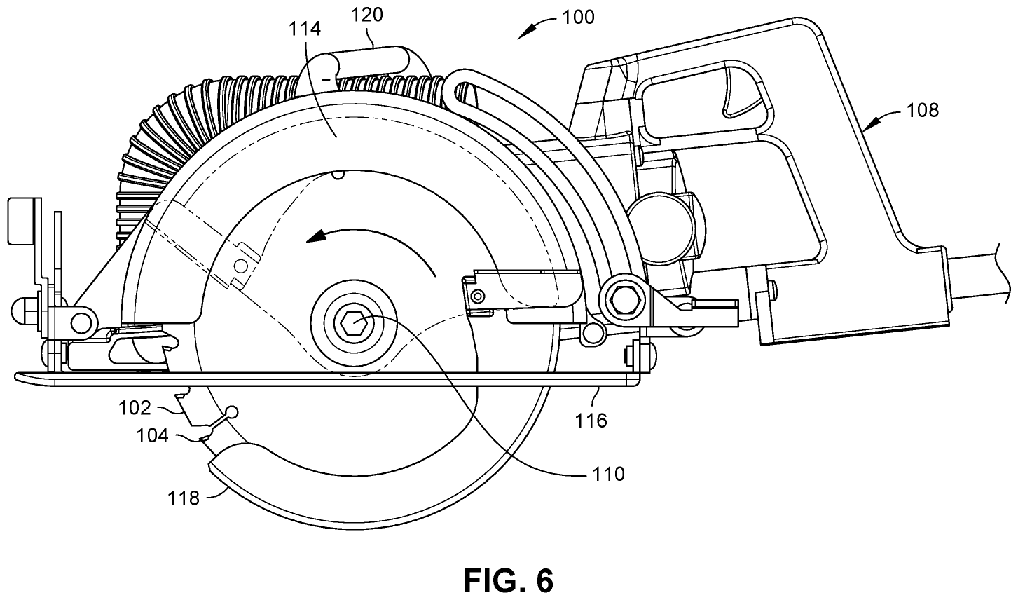

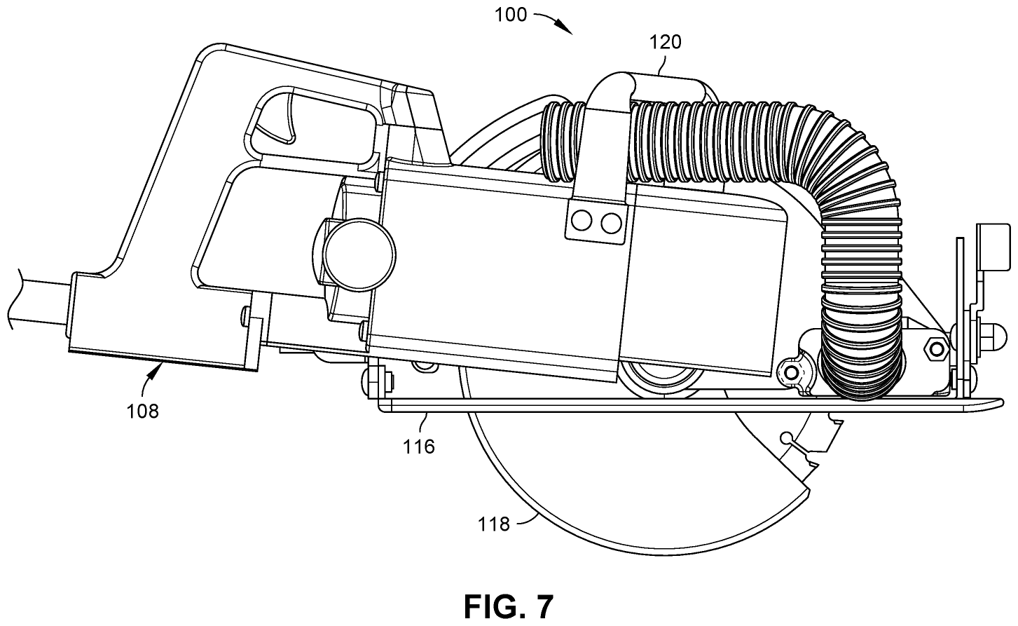

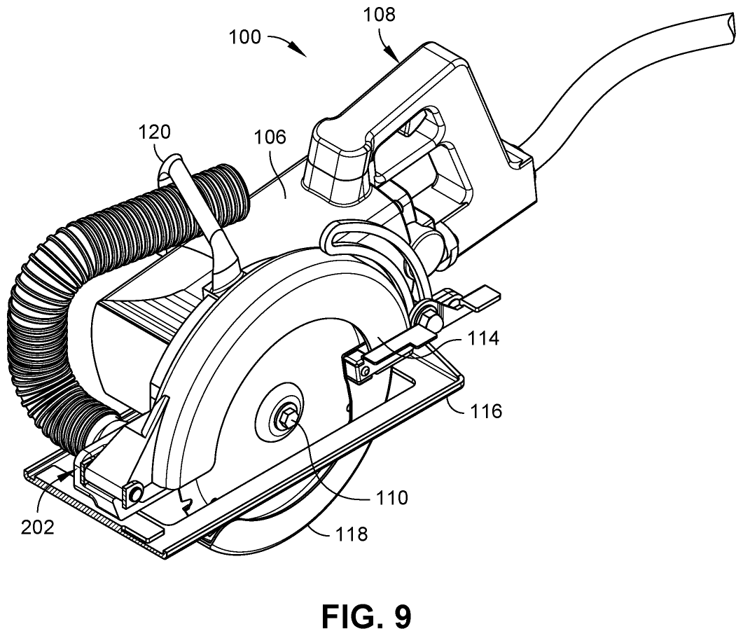

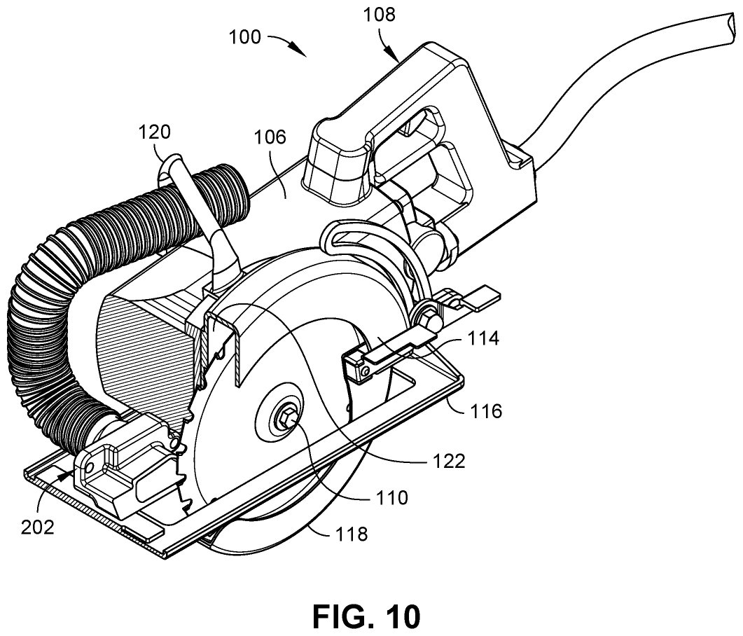

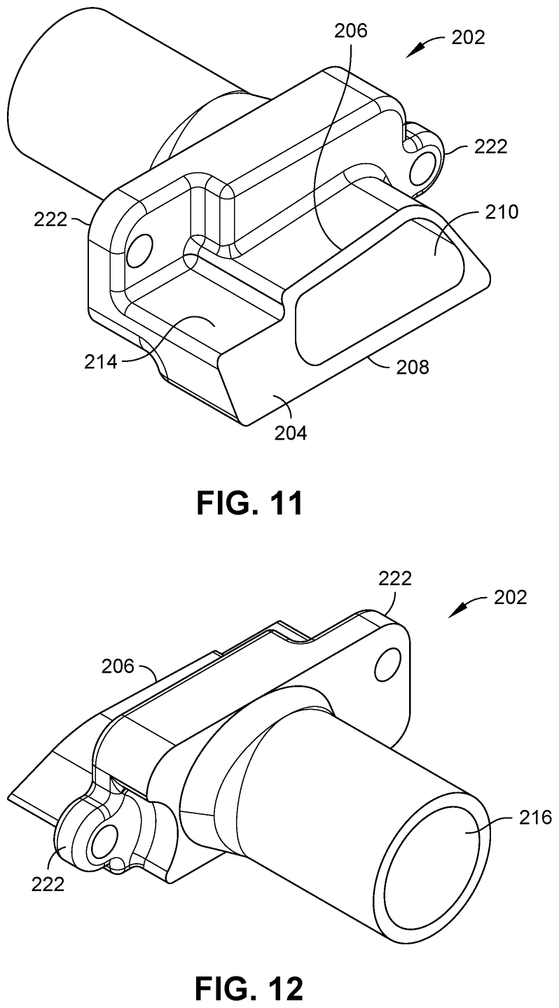

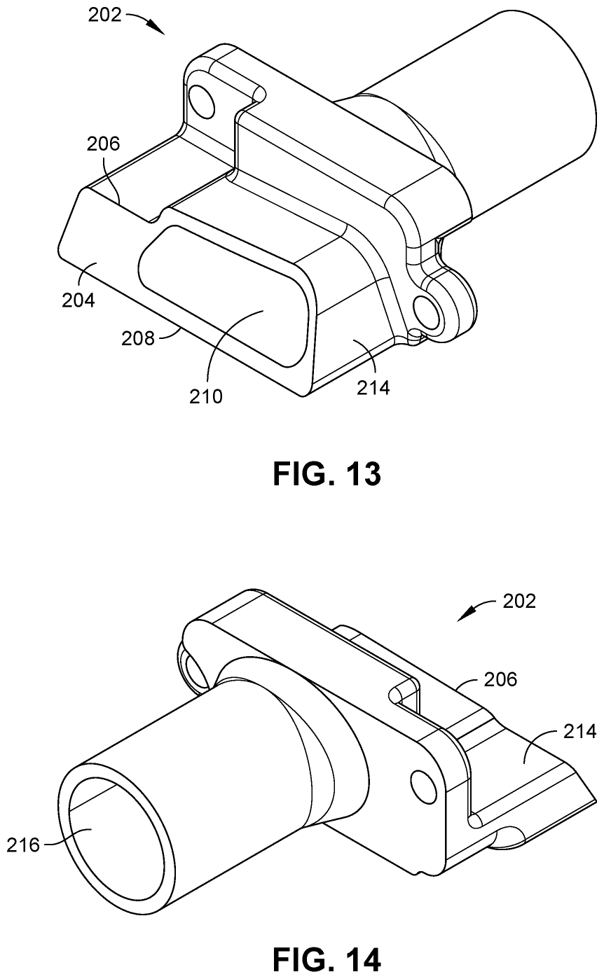

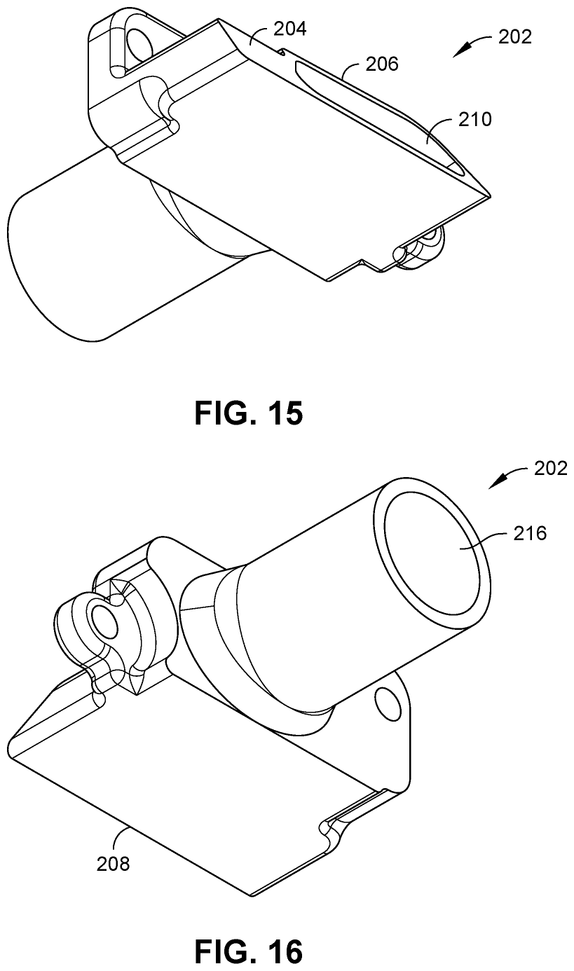

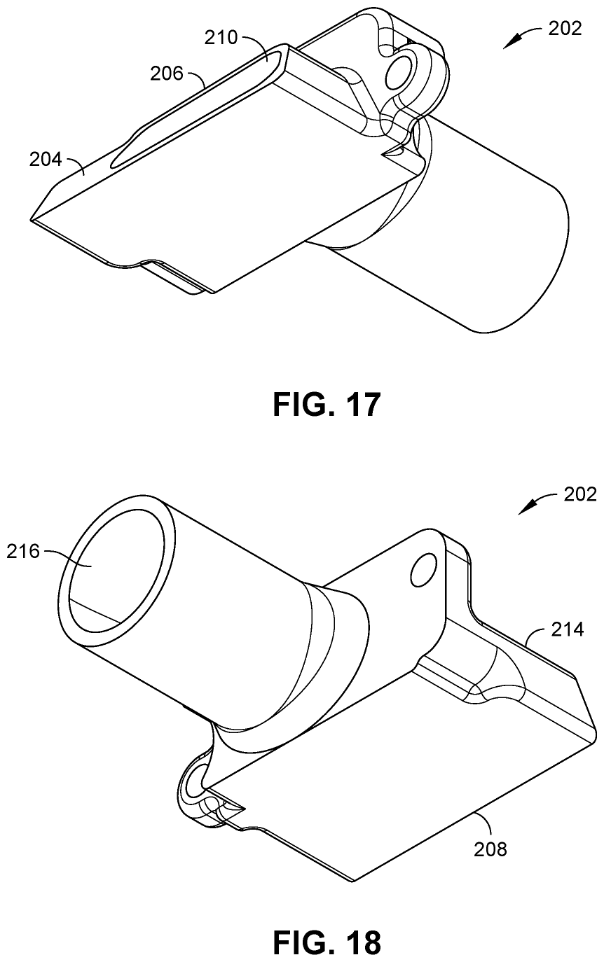

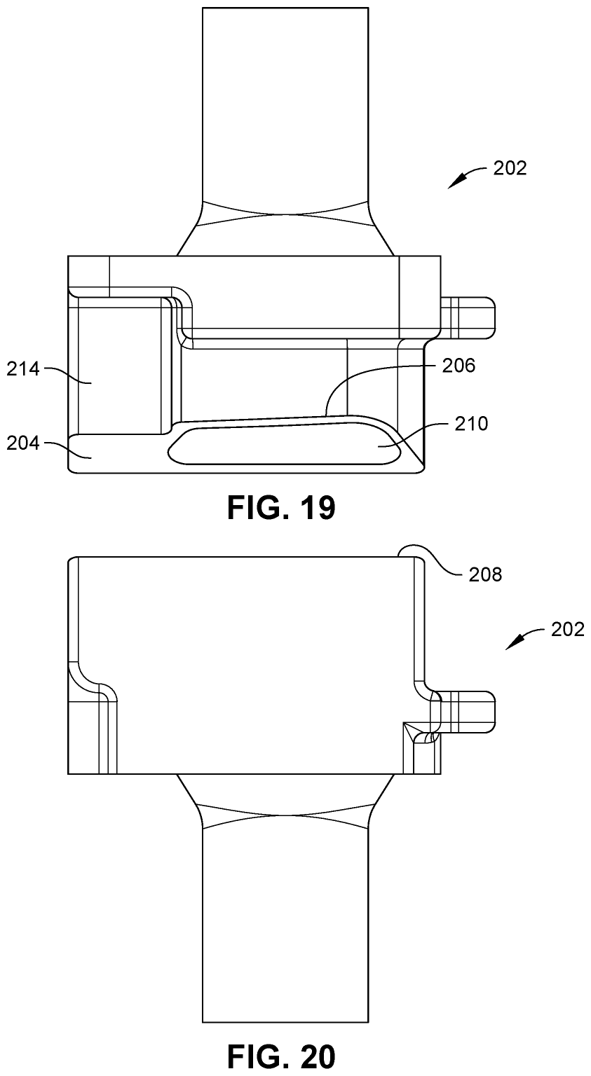

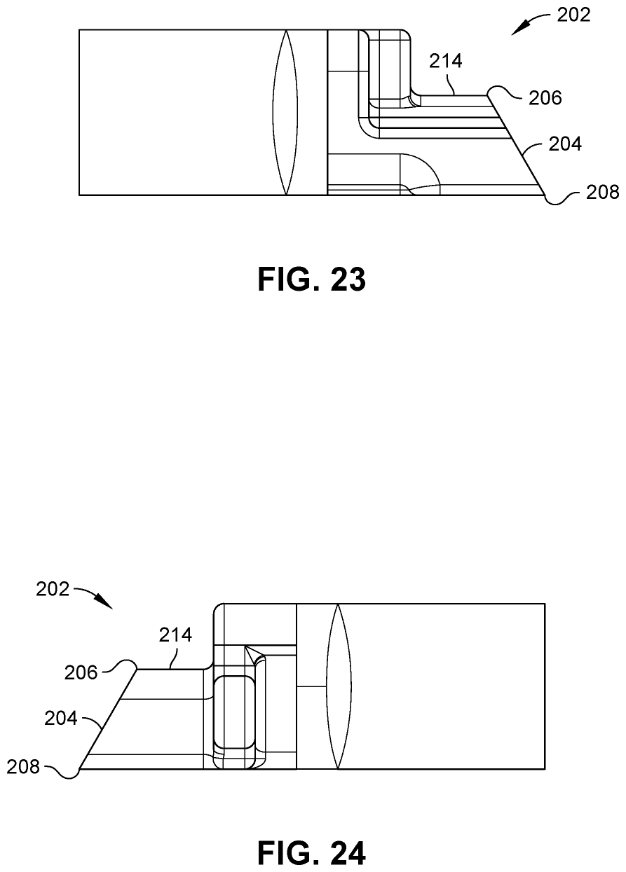

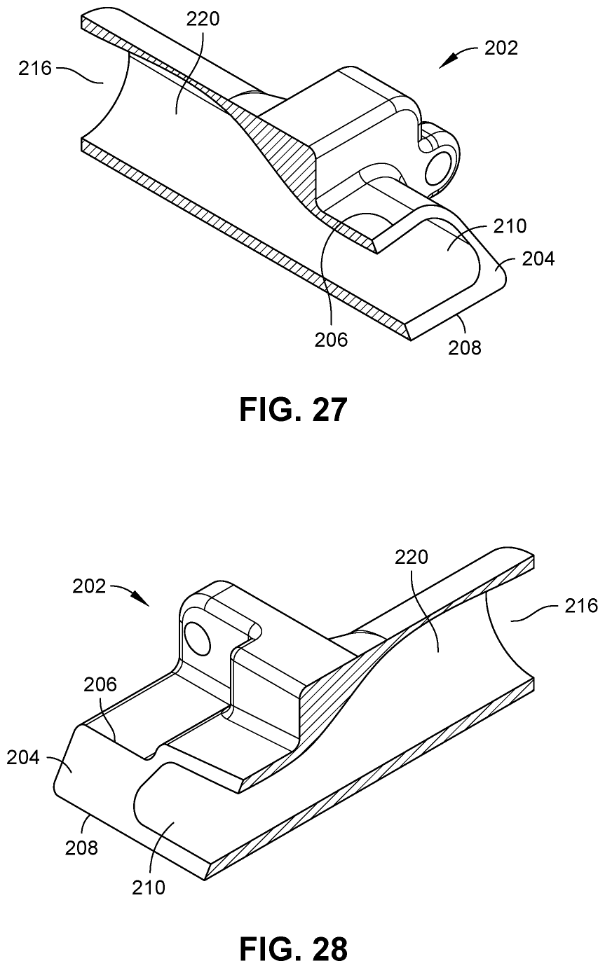

Referring generally to FIGS. 1 through 30, circular saw assemblies 100 are described. The circular saw assemblies 100 use toothed or abrasive discs or blades 102 to cut material using a rotary motion, e.g., where a disc or blade spins about an arbor. In operation, material to be cut is securely held in place, and the saw blade 102 is moved across the material and/or into the material. In the case of a toothed blade 102, as each tooth 104 impacts the material to be cut, a small chip is created, which is then removed from the material by the teeth 104. In general, a circular saw can generate a significant amount of dust and/or debris as material is cut.

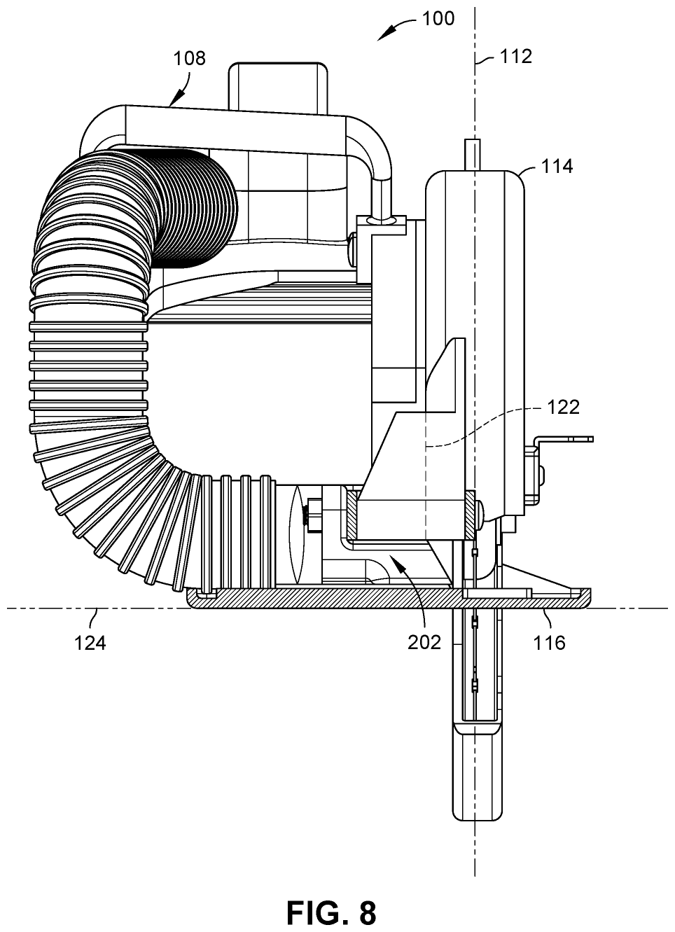

Circular saw blades 102 can be driven by various arrangements of motors and gears. One type of circular saw assembly 100 is a worm-drive circular saw, where perpendicularly mounted worm gears indirectly drive a saw blade 102 from a motor 106 mounted out of line with (e.g., perpendicular to) the saw's arbor. As described with reference to FIGS. 1 through 10, a circular saw assembly 100 includes a tool body 108 and an arbor mount 110 for receiving a blade 102, where the arbor mount 110 extends outwardly from the tool body 108. The blade 102 is configured to connect to the arbor mount 110 and rotate in a plane 112 (FIG. 8) defined perpendicularly to the outward extension of the arbor mount 110.

In embodiments, the circular saw assembly 100 includes a blade guard 114 fixedly connected to the tool body 108 for at least partially enclosing the blade 102, and a support base (e.g., a base plate 116) for supporting the circular saw assembly 110 on a support surface (e.g., on a workpiece to be cut). In such arrangements, there may be limited space for dust and debris collection hardware. For example, the motor 106 may be immediately adjacent to the fixed blade guard 114 on one side of the blade 102, while mounting hardware for allowing the angle of the blade 102 to be changed with respect to the base plate 116 may be immediately adjacent to the blade guard 114 on the other side of the blade 102. Additionally, a table guide may obstruct access to the fixed blade guard 114 from the rear of the saw.

The fixed blade guard 114 may be used with a moveable blade guard 118, where the two guards 114 and 118 cover the blade. The fixed blade guard 114 can be rigidly attached to the motor 106 and a handle 120, while the moveable blade guard 118 can rotate about the center of the blade 102 and can be biased into an extended (e.g., lower) covering position by a biasing device, such as a spring. The moveable blade guard 118 fits within the fixed blade guard 114 and can be rotated into a retracted (e.g., upper) position within the blade guard 114 to allow the circular saw assembly 100 to be employed for cutting material. It should be noted that while a worm-drive circular saw configuration is described herein with some specificity, the systems, techniques, and apparatus of the present disclosure can also be used with other saw configurations, including, but not necessarily limited to: in-line/sidewinder circular saws, hypoid circular saws, and so forth.

In embodiments, the fixed blade guard 114 has a side 122 (FIG. 8) that extends at least substantially parallel to the plane 112 of rotation of the blade 102. The base plate 116 extends along a plane 124 (FIG. 8) defined at least substantially perpendicularly to the plane 112 of rotation of the blade 102. The blade 102 can extend radially from the arbor mount 110 past the plane 124 of extension of the base plate 116. In embodiments of the disclosure, the circular saw assembly 100 includes a dust collection attachment 202 positioned between the side 122 of the fixed blade guard 114 and the base plate 116. The dust collection attachment 202 is configured to be coupled with a vacuum source (not shown) to remove debris drawn into the dust collection attachment 202.

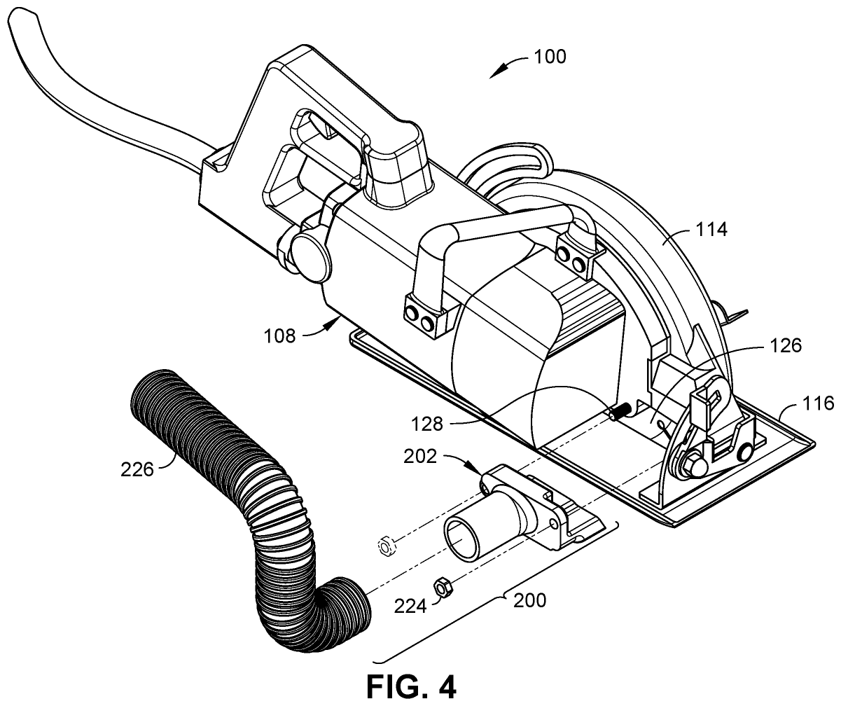

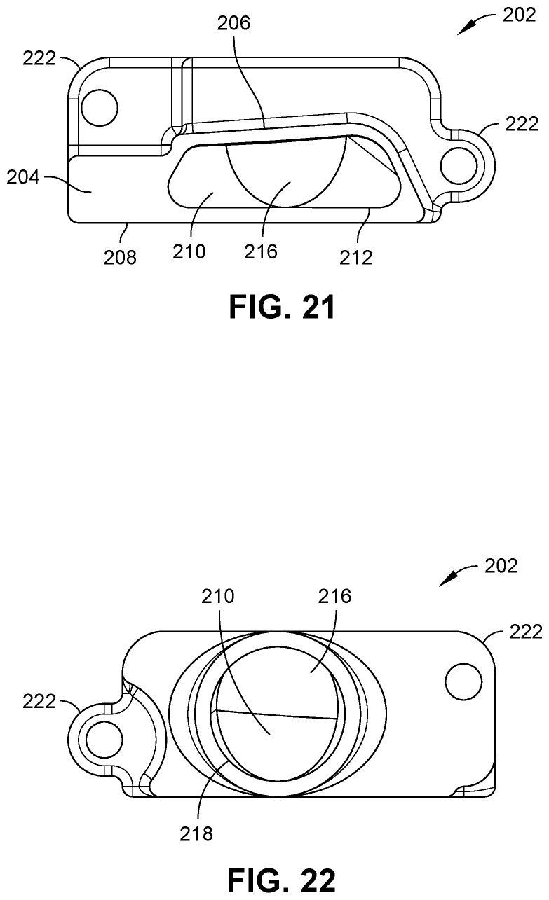

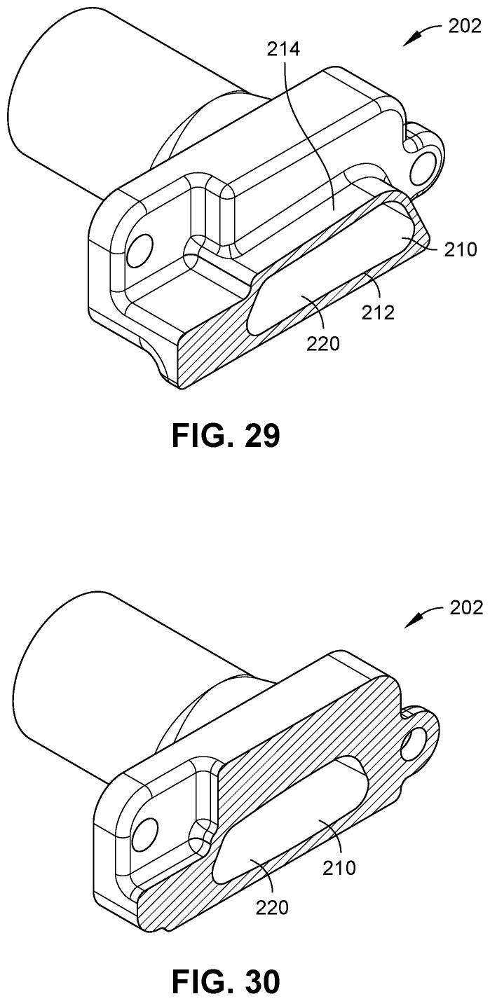

With reference to FIGS. 11 through 30, the dust collection attachment 202 includes an elongated front face 204 to fill space 126 (FIG. 4) between the side 122 of the blade guard 114 and the base plate 116. For example, the elongated front face 204 has a top edge 206 configured to extend along the side 122 of the blade guard 114, and a bottom edge 208 configured to extend along the base plate 116. In embodiments, the elongated front face 204 of the dust collection attachment 202 defines an opening 210 for receiving the debris (e.g., dust, chips) drawn into the dust collection attachment 202, where the opening 210 has a cross-sectional area 212 (FIGS. 21 and 29). The dust collection attachment 202 also includes an extension 214 of the elongated front face 204 away from the saw blade 102.

The dust collection attachment 202 further includes a connection 216 opposite the opening 210 configured for connecting to the vacuum source (not shown), where the connection 216 has a cross-sectional area 218 (FIG. 22). A passageway 220 is defined through the dust collection attachment 202 from the opening 210 at the elongated front face 204 to the connection 216 opposite the opening 210. The cross-sectional area 212 of the passageway 220 at the opening 210 and the cross-sectional area 218 of the passageway 220 at the connection 216 are configured to permit the debris drawn into the dust collection attachment 202 to pass directly through the passageway 220 and toward the vacuum source without obstruction.

In some embodiments, the elongated front face 204 is angled (e.g., beveled) from an edge of the base plate 116 to the side 122 of the blade guard 114 to fill the space 126 between the side 122 of the blade guard 114 and the base plate 116 more completely, e.g., when the base plate 116 extends into closer proximity to the saw blade 102 than the proximity of the side 122 of the blade guard 114 to the blade 102 (as shown in FIG. 8). While the angled elongated front face 204 is shown and described as beveled herein, a beveled flat front face is provided by way of example and is not meant to limit the present disclosure. Thus, in other embodiments, the elongated front face 204 may be shaped differently. For example, the elongated front face 204 may have an inwardly curved shape (e.g., a concave shape) in one or two dimensions, an irregular shape, and so forth.

In some embodiments, the cross-sectional area 212 of the passageway 220 at the opening 210 is greater than the cross-sectional area 218 of the passageway 220 at the connection 216. In some embodiments, the cross-sectional area 212 of the passageway 220 at the opening 210 and the cross-sectional area 218 of the passageway 220 at the connection 216 are within about 20% of one another. For example, the cross-sectional area 212 of the passageway 220 at the opening 210 is about 550 mm² (0.85 in²), and the cross-sectional area 218 of the passageway 220 at the connection 216 is about 530 mm² (0.82 in²). In this example, the cross-sectional area 212 of the passageway 220 at the opening 210 and the cross-sectional area 218 of the passageway 220 at the connection 216 are within about 4% of one another.

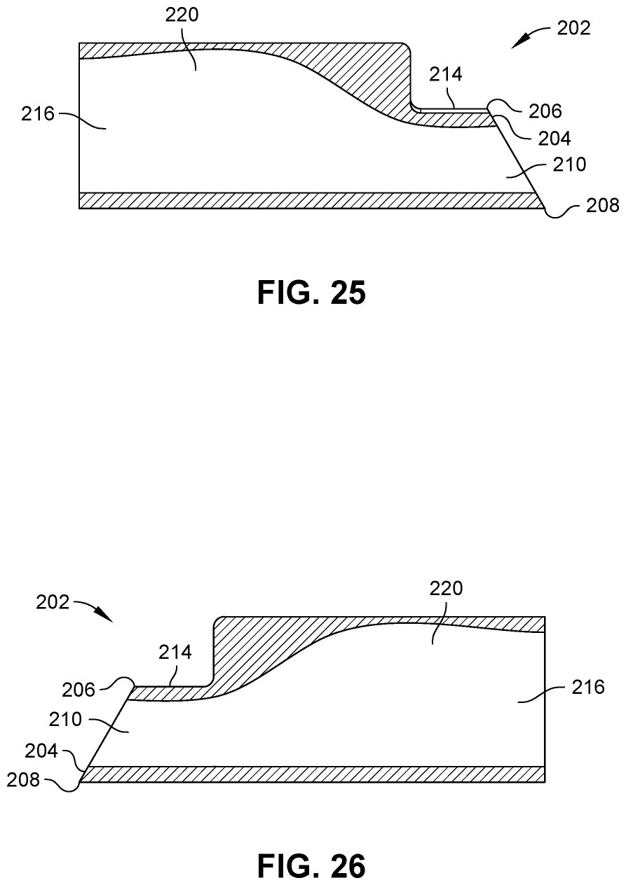

Referring now to FIGS. 25 through 30, in some embodiments the passageway 220 smoothly transitions between the opening 210 of the passageway 220 proximate to the blade 102 and the connection 216 to the passageway 220 opposite the opening 210. For example, the passageway 220 can be shaped according to a computer aided design/computer assisted drafting (CAD) “loft” operation between a generally rectangularly shaped area at the opening 210 and a generally circularly shaped area at the connection 216 for the passageway 220, e.g., where ends of the resulting three-dimensional passageway shape are normal to the cross-sections.

Referring again to FIGS. 1 through 30, systems and apparatus for extracting dust and debris can be used with various circular saw assemblies 100. In some embodiments, a dust collection system 200 includes the dust collection attachment 202, which can be mounted to the tool body 108 of the circular saw assembly between the side 122 of the blade guard 114 and the base plate 116, e.g., as previously described. The dust collection attachment 202 can be fixedly connected to the tool body 108 using various mounting hardware (e.g., screws, bolts, rivets, etc.).

In some embodiments, the dust collection attachment 202 can be attached to the tool body 108 at one or more existing connection points. For example, a dust collection attachment 202 can include one or more tabs 222 with apertures or other connection points for receiving one or more fasteners (e.g., screws 128, FIG. 4) that extend outwardly from the tool body 108 at existing connection points for the blade guard 114, the base plate 116, and so forth. In some embodiments, the dust collection attachment 202 can be mounted to the connection point for the base plate 116, e.g., where the base plate 116 is rotationally connected to the tool body 108 and the base plate 116 rotates with respect to the tool body 108 and the dust collection attachment 202. As shown in the accompanying drawings, the dust collection attachment 202 can also be mounted to another connection point opposite the connection point for the base plate 116.

A dust collection system 200 can include one or more fasteners (e.g., nuts 224) for securing the dust collection attachment 202 to the tool body 108. In some embodiments, existing (e.g., factory installed) hardware (e.g., screws 128, nuts) of a circular saw assembly 100 can be used to secure the dust collection attachment 202 to the tool body 108. In other embodiments, existing hardware (e.g., screws, nuts) of a circular saw assembly 100 can be replaced with one or more fasteners (e.g., screws, nuts 224) of a dust collection system 200 to secure the dust collection attachment 202 to the tool body 108. For instance, factory installed screws 128 of a circular saw assembly 100 can be replaced with longer screws from a dust collection system 200.

In some embodiments, the connection 216 can be configured (e.g., sized) for connecting to, for example, a one and one-quarter inch (1¼″) diameter tube of the vacuum source (e.g., a vacuum hose 226). However, other vacuum tube and/or hose diameters may also be used, including, but not necessarily limited to: three-quarters of an inch (¾″) diameter hoses, one-inch (1″) diameter hoses, and so forth. A vacuum hose 226 may be rigid and/or flexible. A cap (not shown) may be placed on the connection 216 to block the flow of dust and debris from the passageway 220, e.g., when the connection 216 is not connected to a tube or hose.

In some embodiments, the vacuum hose 226 can be sized to extend through the handle 120 and can be positioned to one side of the handle 120 to minimize obstruction of an operator's grip on the handle 120. However, in other embodiments, one or more hooks and/or clips on a side of a circular saw assembly 100 can be used to hold a vacuum hose 226 in place. Further, a coupling, such as a plastic ring or a looped metal strip attached to a side of a circular saw assembly 100 may be used to hold the vacuum hose 226 in place. In some embodiments, a circular saw assembly 100 may also include a hook, loop, clip, or another holder integrally formed as part of and/or connected to a handle 120 (e.g., to one side of the handle 120).

Without wishing to be bound by any particular theory or principle of operations, it is believed that the elongated front face 204 that fills the space 126 between the side 122 of the blade guard 114 and the base plate 116 (e.g., by angling from an edge of the base plate 116 to the side 122 of the blade guard 114) can reduce or minimize the flow of dust and debris from out of the blade guard 114 and into the surrounding environment, as more dust and debris is pulled into the vacuum hose 226. Again, without wishing to be bound by any particular theory or principle of operations, it is also believed the cross-sectional area 212 of the passageway 220 at the opening 210 being greater than or nearly equal to the cross-sectional area 218 of the passageway 220 at the connection 216, and the direct passageway 220 through the dust collection attachment 202 (FIGS. 21 and 22), can reduce or minimize the flow of dust and debris from out of the blade guard 114 and into the surrounding environment, as more dust and debris is pulled into the vacuum hose 226.

In some embodiments, a dust collection attachment 202 can be used with an adapter (e.g., a gasket). For example, the dust collection attachment 202 can have a profile at the top edge 206 that is substantially straight (e.g., for attachment to a circular saw assembly 100 having a generally straight termination at the side 122 of the blade guard 114. However, another circular saw assembly 100 may have a more curved profile at the side 122 of a blade guard 114. In this instance, an adapter such as a gasket (e.g., a foam gasket) and/or another universal adapter may be used to bridge between the dust collection attachment 202 and the side 122 of the blade guard 114 to prevent airflow between the attachment and the side of the blade guard. Further, in some embodiments, one or more parts of the dust collection attachment 202 can be formed from a compliant (e.g., flexible, elastomeric) material, such as the top edge 206 of the dust collection attachment 202, the bottom edge 208 of the dust collection attachment 202 and so forth. In this example, various compliant surfaces of the dust collection attachment 202 can be formed in a co-molding manufacturing operation.

In some embodiments, the dust collection attachment 202 can be manufactured using an additive manufacturing process, which causes the interior of the dust collection attachment 202 to be free from obstructions. For example, the dust collection attachment 202 is formed using a 3D printer that enables complex shapes that would not otherwise be possible without leaving residual obstructions, such as seams (e.g., as a product of a multi-part arrangement, such as multiple injection-molded pieces) and/or tooling marks (e.g., as a product of machining a workpiece). In the present example, the dust collection attachment 202 can be formed using a 3D printing operation where the elongated front face 204 is laid down as a first layer on the bed of a 3D extrusion printer, such as a fused deposition modeling (FDM) or fused filament fabrication (FFF) printer.

In some embodiments, the dust collection system 200 can also include a blade guard extender or another extender at an end of the fixed blade guard 114 and configured to extend the interior of the blade guard 114. The blade guard extender can be used to enhance the pulling of the debris into the dust collection attachment 202. In embodiments, the blade guard extender may be formed from a flexible or viscoelastic material, such as rubber or a rubber-like solid (e.g., an elastic polymer, elastomer). In this manner, a blade guard extender may be used with a circular saw assembly 100 that allows the angle of the blade 102 to be changed with respect to the base plate 116, such as a forty-five-degree (45°) bevel table. The blade guard extender can be fixedly connected to the blade guard 114 using various mounting hardware (e.g., screws, bolts, rivets, etc.).

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

What is claimed is:

1. A circular saw assembly comprising:
a tool body;
an arbor mount for receiving a circular saw blade, the arbor mount extending outwardly from the tool body, the circular saw blade configured to connect to the arbor mount and rotate in a plane defined perpendicularly to the outward extension of the arbor mount;
a blade guard fixedly connected to the tool body for at least partially enclosing the circular saw blade, the blade guard having a side that extends at least substantially parallel to the plane of rotation of the circular saw blade;
a support base connected to the tool body for supporting the circular saw assembly on a support surface, the support base extending along a plane defined at least substantially perpendicularly to the plane of rotation of the circular saw blade, the circular saw blade configured to extend radially from the arbor mount past the plane of extension of the support base; and
a dust collection attachment positioned between the side of the blade guard and the support base for coupling with a vacuum source to remove debris drawn into the dust collection attachment, the dust collection attachment including
an elongated front face for filling space between the side of the blade guard and the support base, the elongated front face having
a top edge configured to extend along the side of the blade guard,
a bottom edge configured to extend along the support base, and
defining an opening for receiving the debris drawn into the dust collection attachment, the opening having a first cross-sectional area,
an extension of the elongated front face away from the circular saw blade,
a connection opposite the opening, the connection configured for connecting to the vacuum source, the connection having a second cross-sectional area, and
a passageway defined through the dust collection attachment from the opening at the elongated front face to the connection opposite the opening, the first cross-sectional area of the passageway at the opening and the second cross-sectional area of the passageway at the connection configured to permit the debris drawn into the dust collection attachment to pass directly through the passageway without obstruction.

2. The circular saw assembly as recited in claim 1, wherein the support base is rotationally connected to the tool body.

3. The circular saw assembly as recited in claim 1, wherein the elongated front face of the dust collection attachment is angled from the support base to the side of the blade guard.

4. The circular saw assembly as recited in claim 1, wherein the cross-sectional area of the passageway at the opening is greater than the cross-sectional area of the passageway at the connection.

5. The circular saw assembly as recited in claim 1, wherein the cross-sectional area of the passageway at the opening and the cross-sectional area of the passageway at the connection are within 20% of one another.

6. The circular saw assembly as recited in claim 1, wherein passageway smoothly transitions between the opening of the passageway and the connection to the passageway opposite the opening.

7. The circular saw assembly as recited in claim 1, wherein the opening of the passageway is generally rectangular shaped and the connection to the passageway opposite the opening is generally circular shaped.

8. The circular saw assembly as recited in claim 1, wherein the dust collection attachment comprises tabs for receiving mounting hardware to connect the dust collection attachment to the tool body.

9. The circular saw assembly as recited in claim 1, wherein the connection is configured for connecting to a tube of the vacuum source.

10. A dust collection attachment to be positioned between a side of a blade guard for a circular saw blade and a support base of a circular saw assembly, the dust collection attachment for coupling with a vacuum source to remove debris drawn into the dust collection attachment, the dust collection attachment comprising:
an elongated front face for filling space between the side of the blade guard and the support base, the elongated front face angled from the support base to the side of the blade guard, the elongated front face having
a top edge configured to extend along the side of the blade guard,
a bottom edge configured to extend along the support base, and
defining an opening for receiving the debris drawn into the dust collection attachment, the opening having a first cross-sectional area,
an extension of the elongated front face away from the circular saw blade,
a connection opposite the opening, the connection configured for connecting to the vacuum source, the connection having a second cross-sectional area, and
a passageway defined through the dust collection attachment from the opening at the elongated front face to the connection opposite the opening, the first cross-sectional area of the passageway at the opening and the second cross-sectional area of the passageway at the connection configured to permit the debris drawn into the dust collection attachment to pass directly through the passageway without obstruction.

11. The dust collection attachment as recited in claim 10, wherein the cross-sectional area of the passageway at the opening is greater than the cross-sectional area of the passageway at the connection.

12. The dust collection attachment as recited in claim 10, wherein the cross-sectional area of the passageway at the opening and the cross-sectional area of the passageway at the connection are within 20% of one another.

13. The dust collection attachment as recited in claim 10, wherein passageway smoothly transitions between the opening of the passageway and the connection to the passageway opposite the opening.

14. The dust collection attachment as recited in claim 10, wherein the opening of the passageway is generally rectangular shaped and the connection to the passageway opposite the opening is generally circular shaped.

15. The dust collection attachment as recited in claim 10, wherein the dust collection attachment comprises tabs for receiving mounting hardware to connect the dust collection attachment to a tool body of the circular saw assembly.

16. The dust collection attachment as recited in claim 10, wherein the connection is configured for connecting to a tube of the vacuum source.

17. A dust collection attachment to be positioned between a side of a blade guard for a circular saw blade and a support base of a circular saw assembly, the dust collection attachment for coupling with a vacuum source to remove debris drawn into the dust collection attachment, the dust collection attachment comprising:
an elongated front face for filling space between the side of the blade guard and the support base, the elongated front face angled from the support base to the side of the blade guard, the elongated front face having
a top edge configured to extend along the side of the blade guard,
a bottom edge configured to extend along the support base, and
defining an opening for receiving the debris drawn into the dust collection attachment, the opening being generally rectangular shaped and having a first cross-sectional area,
an extension of the elongated front face away from the circular saw blade,
a connection opposite the opening, the connection configured for connecting to the vacuum source, the connection being generally circular shaped and having a second cross-sectional area, and
a passageway defined through the dust collection attachment from the opening at the elongated front face to the connection opposite the opening, the first cross-sectional area of the passageway at the opening and the second cross-sectional area of the passageway at the connection configured to permit the debris drawn into the dust collection attachment to pass directly through the passageway without obstruction.

18. The dust collection attachment as recited in claim 17, wherein the cross-sectional area of the passageway at the opening is greater than the cross-sectional area of the passageway at the connection.

19. The dust collection attachment as recited in claim 17, wherein the cross-sectional area of the passageway at the opening and the cross-sectional area of the passageway at the connection are within 20% of one another.

20. The dust collection attachment as recited in claim 17, wherein passageway smoothly transitions between the opening of the passageway and the connection to the passageway opposite the opening.
